(19) United States
(12) Patent Application Publication
(10) Pub. No.: US 2024/0221228 A1
(43) Pub. Date: Jul. 4, 2024

(54) DETECTION AND INDICATION OF GEOMETRY RECONSTRUCTION ARTIFACTS IN POINT CLOUDS BASED ON LOCAL DENSITY

(71) Applicants: SONY GROUP CORPORATION, TOKYO (JP); SONY CORPORATION OF AMERICA, NEW YORK, NY (US)

(72) Inventors: ALEXANDRE ZAGHETTO, SAN JOSE, CA (US); DANILLO GRAZIOSI, FLAGSTAFF, AZ (US); ALI TABATABAI, CUPERTINO, CA (US)

(21) Appl. No.: 18/147,944

(22) Filed: Dec. 29, 2022

(51) Int. Cl. G06T 9/00; G06T 7/62

(52) U.S. Cl. CPC G06T 9/001; G06T 7/62

(57) ABSTRACT

An electronic device and method for detection and indication of geometry reconstruction artifacts is provided. The electronic device acquires a reference point cloud, encodes the reference point cloud to generate encoded point cloud data, and decodes the encoded point cloud data to generate a test point cloud. The electronic device further generates a first local density map and a second local density map for points of the reference point cloud and the test point cloud, respectively. The electronic device generates a final density map based on the first local density map and the second local density map, and further generates supplementary information based on the final density map. The supplementary information includes missing points data corresponding to regions of the test point cloud that include artifacts such as holes or includes descriptors for the regions that include the artifacts. The electronic device signals the supplementary information to a decoder.

### CROSS-REFERENCE TO RELATED APPLICATIONS/INCORPORATION BY REFERENCE

None.

### FIELD

Various embodiments of the disclosure relate to three-dimensional (3D) point cloud encoding and reconstruction. More specifically, various embodiments of the disclosure relate to detection and indication of geometry reconstruction artifacts in point clouds based on local density estimation.

### BACKGROUND

Advancements in the field of point cloud compression (PCC) have led to the development of PCC approaches that enable efficient representation of data associated with 3D points of a point cloud. Typically, a point cloud may include many unstructured 3D points. Each 3D point may include geometrical information (for example, coordinates (i.e., x, y, and z coordinates) of the corresponding 3D point) and attribute information associated with the corresponding 3D point (for example, color information, reflectance information, or opacity information). Thus, each 3D point of the point cloud may include a significant amount of data. The point cloud data may require compression via a PCC approach for storage, processing, or transmission of the point cloud. However, reconstruction (via decoding) of the point cloud at a PCC decoder may lead to appearance of artifacts (such as loss of 3D points of the (original) point cloud) in the reconstructed point cloud. The detection and subsequent mitigation of such artifacts in the reconstructed point cloud geometry may be required to have high-fidelity 3D geometry data for various applications such as game development or 3D videos.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for detection and indication of geometry reconstruction artifacts in point clouds based on local density, is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a diagram that illustrates an exemplary network environment for detection and indication of geometry reconstruction artifacts in point clouds based on local density, in accordance with an embodiment of the disclosure.

FIG. 2 is a block diagram that illustrates an exemplary electronic device of FIG. 1, in accordance with an embodiment of the disclosure.

FIG. 3 is a diagram that illustrates an exemplary processing pipeline for estimation of local density maps for three-dimensional (3D) points of a reference point cloud and a test point cloud, in accordance with an embodiment of the disclosure.

FIG. 4A is a diagram that illustrates an exemplary scenario for generation of a first local density map for 3D points of a reference point cloud, in accordance with an embodiment of the disclosure.

FIG. 4B is a diagram that illustrates an exemplary scenario for generation of a second local density map for 3D points of a test point cloud, in accordance with an embodiment of the disclosure.

FIG. 5 is a diagram that illustrates an exemplary scenario for generation of a final density map based on local density maps associated with 3D points of a reference point cloud and a test point cloud, in accordance with an embodiment of the disclosure.

FIG. 6 is a diagram that illustrates an exemplary processing pipeline for generation and signaling of supplementary information to a Point Cloud Compression (PCC) decoder, in accordance with an embodiment of the disclosure.

FIG. 7 is a diagram that illustrates an exemplary processing pipeline for generation and signaling of supplementary information to a PCC decoder, in accordance with an embodiment of the disclosure.

FIG. 8 is a diagram that illustrates an exemplary processing pipeline for mitigation of geometry reconstruction artifacts in a reconstructed point cloud based on received supplementary information, in accordance with an embodiment of the disclosure.

FIG. 9 is a diagram that illustrates an exemplary processing pipeline for mitigation of geometry reconstruction artifacts in a reconstructed point cloud based on received supplementary information, in accordance with an embodiment of the disclosure.

FIG. 10 is a flowchart that illustrates operations for an exemplary method for detection and indication of geometry reconstruction artifacts in point clouds based on local density, in accordance with an embodiment of the disclosure.

### DETAILED DESCRIPTION

The following described implementations may be found in a disclosed electronic device method for detection and indication of geometry reconstruction artifacts in point clouds based on local density. Exemplary aspects of the disclosure provide an electronic device (for example, a computing device, a gaming console, or a smart wearable device) that may indicate regions of the point clouds that include geometry reconstruction artifacts and may facilitate in mitigation of geometry reconstruction artifacts that appear in point clouds during reconstruction.

The electronic device may acquire a reference point cloud of an object and may encode the reference point cloud to generate encoded point cloud data. At the encoder-side, the encoded point cloud data may be decoded to generate a test point cloud. The electronic device may generate a first local density map for three-dimensional (3D) points of the reference point cloud and a second local density map for 3D points of the test point cloud. The electronic device may generate a final density map based on a comparison between the first local density map and the second local density map. Thereafter, the electronic device may generate supplementary information based on the final density map. The supplementary information may include missing points data corresponding to regions of the test point cloud that include geometry reconstruction artifacts. Alternatively, the supplementary information may include one or more descriptors for the regions that include the geometry reconstruction artifacts. The electronic device may signal the supplementary information to a Point Cloud Compression (PCC) decoder.

An original point cloud, generated based on a 3D scan (using images and depth information) of an object, may be compressed via encoding of 3D points of the original point cloud using suitable PCC techniques. The point clouds may be compressed for storage, processing, and transfer of the point clouds since each 3D point of the original point cloud may include a significant amount of data. The necessity for compression of the original point cloud may arise due to memory and computational constraints of electronic devices and bandwidth constraints of communication channels. Once the original point cloud is compressed at the encoder-side, encoded point cloud data (representative of the geometry of the original point cloud or the object) may be transmitted to the decoder-side. The original point cloud may be reconstructed based on decoding of the received encoded point cloud data. The decoding operations may lead to addition of artifacts such as holes in the reconstructed point cloud. The size, volume, or number of such artifacts in the reconstructed point clouds may be more pronounced if encoding and decoding operations are realized using neural network-based codecs. In some instances, such artifacts may reduce the quality of the reconstructed point clouds and may impact usability of such point clouds in 3D rendering applications, such as extended reality or 3D computer games.

To address the issues, the proposed electronic device may detect geometry reconstruction artifacts in a test point cloud generated by the electronic device. The geometry reconstruction artifacts may be detected due to presence of holes that appear in the test point cloud after decoding of encoded point cloud data. The electronic device may encode the reference point cloud to generate the encoded point cloud data and may generate the test point cloud to determine artifacts such as holes that may appear after reconstruction of the reference point cloud at the decoder-side. The electronic device may indicate one or more regions of the test point cloud that include such artifacts. The electronic device may signal supplementary information to the PCC decoder along with the encoded point cloud data (associated with the reference point cloud). The signaling of the supplementary information may enable a PCC decoder to predict one or more regions of a point cloud that may include geometry reconstruction artifacts. By using the supplementary information, the PCC decoder may perform suitable operations to mitigate potential geometry reconstruction artifacts that may appear in the one or more regions of the point cloud after the decoding of the encoded point cloud data. For example, the geometry reconstruction artifacts may be mitigated by filling a region (e.g., a hole region) of the point cloud using missing points data (extracted from the supplementary information). Thus, the supplementary information may facilitate the PCC decoder to efficiently post-process a reconstructed point cloud and remove maximum reconstructions artifacts such holes from the reconstructed point cloud. This may improve quality and fidelity of the post-processed point clouds, eventually making such point clouds suitable for applications such as 3D game development or 3D animation.

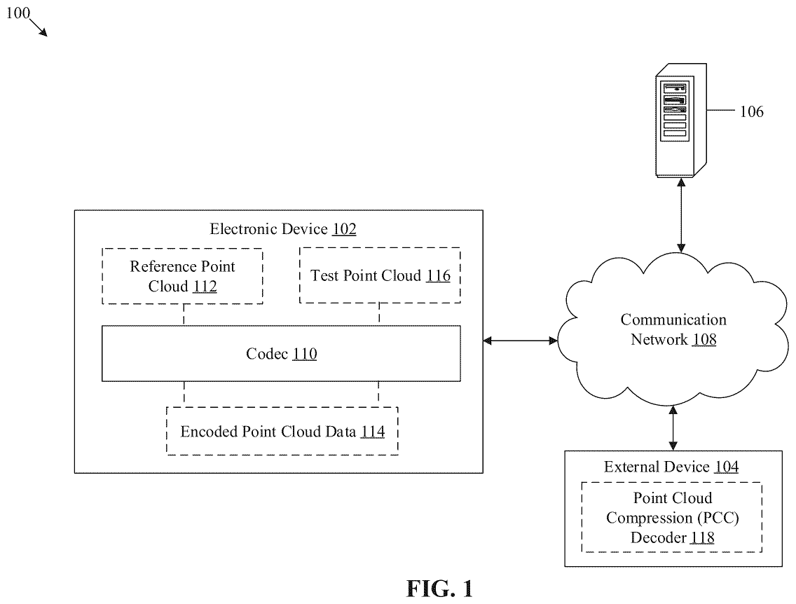

FIG. 1 is a diagram that illustrates an exemplary network environment for detection and indication of geometry reconstruction artifacts in point clouds based on local density, in accordance with an embodiment of the disclosure. With reference to FIG. 1, there is shown a network environment 100. The network environment 100 includes an electronic device 102, an external device 104, and a server 106. The electronic device 102 may communicate with the external device 104 and the server 106, through one or more networks (such as a communication network 108). The electronic device 102 may include a codec 110. The codec 110 may receive a reference point cloud 112 as input and may generate, as output, encoded point cloud data 114 based on the reference point cloud 112. Further, the codec 110 may generate a test point cloud 116 as output based on the encoded point cloud data 114. The external device 104 may include a PCC decoder 118.

The electronic device 102 may include suitable logic, circuitry, interfaces, and/or code that may be configured to detect geometry reconstruction artifacts such as holes in one or more regions of a test point cloud (such as the test point cloud 116) and generate supplementary information that includes missing points data or descriptors for volumes that correspond to such regions. The electronic device 102 may transmit the encoded point cloud data 114 and the supplementary information to the external device 104 (i.e., the PCC decoder 118), via the communication network 108. Examples of the electronic device 102 may include, but are not limited to, a computing device, a video-conferencing system, an augmented reality (AR) device, a virtual reality (VR device), a mixed reality (MR) device, a game console, a smart wearable device, a mainframe machine, a server, a computer workstation, and/or a consumer electronic (CE) device.

The external device 104 may include suitable logic, circuitry, interfaces, and/or code that may be configured to communicate with the electronic device 102, via the communication network 108. In accordance with an embodiment, the external device 104 may be configured to receive the encoded point cloud data 114 and the supplementary information from the electronic device 102. The external device 104 may be configured to reconstruct, via the PCC decoder 118, a point cloud based on the encoded point cloud data 114. The external device 104 may be further configured to use the supplementary information to apply post-processing operations on the reconstructed point cloud and generate a final point cloud that is mostly free of geometry reconstruction artifacts (e.g., holes). Examples of the external device 104 may include, but are not limited to, a display system, a computing device, a gaming device, a mobile phone, a television, or an electronic device that can store or render multimedia content.

The server 106 may include suitable logic, circuitry, interfaces, and/or code that may be configured to generate reference point clouds (for example, the reference point cloud 112) of 3D object(s) in 3D space. The server 106 may be configured to use images and depth information of the object(s) to generate the reference point clouds. The server 106 may store the reference point clouds and information associated with the reference point clouds for future requirements. The server 106 may receive a request from the electronic device 102 for the reference point cloud 112. The server 106 may transmit the reference point cloud 112 to the electronic device 102 based the received request. The server 106 may execute operations through web applications, cloud applications, HTTP requests, repository operations, file transfer, and the like. Example implementations of the server 106 may include, but are not limited to, a database server, a file server, a web server, an application server, a mainframe server, a cloud computing server, or a combination thereof. In at least one embodiment, the server 106 may be implemented as a plurality of distributed cloud-based resources by use of several technologies that are well known to those ordinarily skilled in the art. A person with ordinary skill in the art will understand that the scope of the disclosure may not be limited to the implementation of the server 106 and the electronic device 102 as two separate entities. In certain embodiments, the functionalities of the server 106 can be incorporated in its entirety or at least partially in the electronic device 102, without a departure from the scope of the disclosure.

The communication network 108 may include a communication medium through which the electronic device 102, the external device 104, and the server 106 may communicate with each other. The communication network 108 may be a wired or wireless communication network. Examples of the communication network 108 may include, but are not limited to, Internet, a Wireless Fidelity (Wi-Fi) network, a Personal Area Network (PAN), a Local Area Network (LAN), or a Metropolitan Area Network (MAN). The electronic device 102 may be configured to connect to the communication network 108, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The codec 110 may include suitable logic, circuitry, code, and/or interfaces that may be configured to encode the reference point cloud 112 of an object and decode the encoded point cloud data 114. In accordance with an embodiment, the codec 110 may be configured to partition the reference point cloud 112 into a plurality of 3D blocks and encode each 3D block of the reference point cloud 112 to generate a coded bitstream. In some embodiments, the codec 110 may be also configured to generate the supplementary information for the PCC decoder 118.

In accordance with an embodiment, the codec 110 may be configured to reconstruct the reference point cloud 112 based on the encoded point cloud data 114. The reconstruction may lead to the generation of the test point cloud 116. By way of example, and not limitation, the codec 110 may be implemented as a Deep Neural Network (in the form of trained model data with computer-executable instructions) that can be executed on a Graphical Processing Unit (GPU), a Central Processing Unit (CPU), a Tensor Processing Unit (TPU), a Reduced Instruction Set Computing (RISC), Application-Specific Integrated Circuit (ASIC), or a Complex Instruction Set Computing (CISC) processor, a co-processor, and/or a combination thereof.

The codec 110 may include encoder-decoder pairs, such as an encoder and decoder-1, . . . , and an encoder and decoder-N. Each of such encoder-decoder pairs may include an associated neural network model. For example, the encoder and decoder-1 1104A may include a DNN model-1.

In some other embodiments, the codec 110 may be implemented as a DNN on a specialized hardware interfaced with other computational circuitry of the electronic device 102. Examples of the specialized hardware may include, but are not limited to, a field programmable gate array (FPGA), programmable logic devices (PLDs), an ASIC, a programmable ASIC (PL-ASIC), application specific integrated parts (ASSPs), and a System-on-Chip (SOC) based on standard microprocessors (MPUs) or digital signal processors (DSPs). In accordance with an embodiment, the codec 110 may be also interfaced with a GPU to parallelize operations of the codec 110.

The reference point cloud 112 may correspond to a geometrical representation of an object in 3D space and may include a set of 3D points. Each 3D point of the reference point cloud 112 may be a voxel. In accordance with an embodiment, the electronic device 102 may acquire the reference point cloud 112 from the server 106. In accordance with another embodiment, the electronic device 102 may generate the reference point cloud 112 based on a 3D scan of the object. The 3D points of the reference point cloud 112 may include geometrical information (i.e., positions or coordinates of 3D points in the reference point cloud 112) and attribute information associated with the 3D points. The attribute information may include color information, reflectance information, opacity information, normal vector information, material identifier information, texture information, and the like.

The encoded point cloud data 114 may be generated based on encoding of the reference point cloud 112. The encoded point cloud data 114 may include encoded geometrical information (i.e., an encoding of 3D point cloud geometry) associated with the reference point cloud 112. In certain embodiments, the encoded point cloud data 114 may include encoded attribute information associated with the reference point cloud 112. The electronic device 102 may transmit the encoded point cloud data 114 to the external device 104 (i.e., the PCC decoder 118) as a coded bitstream.

The test point cloud 116 may be a reconstructed point cloud that corresponds to the reference point cloud 112. The test point cloud 116 may similarly include geometrical information (for example, coordinates of the 3D points of the test point cloud 116) and attribute information associated with the 3D points of the test point cloud 116. The electronic device 102 may reconstruct the test point cloud 116 based on the encoded point cloud data 114. After reconstruction, one or more regions of the test point cloud 116 may include geometry reconstruction artifacts such as holes. A hole in a reconstructed point cloud (i.e., the test point cloud 116) may correspond to a 3D volume in which 3D points that correspond to an original point cloud (i.e., the reference point cloud 112) are missing as result of the reconstruction.

The PCC decoder 118 may include suitable logic, circuitry, and/or interfaces that may be configured to receive, via the communication network 108, the encoded point cloud data 114 as a coded bitstream and the supplementary information from the electronic device 102. The supplementary information may facilitate in mitigation of geometry reconstruction artifacts that may be detected in the reconstructed point cloud. The PCC decoder 118 may be further configured to reconstruct a point cloud based on the encoded point cloud data 114. The encoded point cloud data 114 (or the coded bitstream) may include encoded point cloud data associated with a plurality of blocks. The PCC decoder 118 may individually decode each encoded block of the plurality of encoded blocks to generate a plurality of decoded blocks. The PCC decoder 118 may further binarize and merge the plurality of decoded blocks for reconstruction of the point cloud. The PCC decoder 118 may use the received supplementary information to predict regions of the reconstructed point cloud that may include geometry reconstruction artifacts. The PCC decoder 118 may use the received supplementary information to post-process the point cloud and generate a final point cloud. The final point cloud may have minimum reconstruction artifacts (e.g., holes) or may be free of geometry reconstruction artifacts.

The PCC decoder 118 may be implemented as a Deep Neural Network (in the form of computer-executable code) on a GPU, a CPU, a TPU, a RISC processor, an ASIC processor, a CISC processor, a co-processor, and/or a combination thereof. In some other embodiments, the PCC decoder 118 may be implemented as a Deep Neural Network on a specialized hardware interfaced with other computational circuitries of the electronic device 102. In such implementations, the PCC decoder 118 may be associated with a specific form factor on a specific computational circuitry. Examples of the specific computational circuitry may include, but are not limited to, a FPGA, PLDs, an ASIC, a PL-ASIC, ASSPs, and a SOC based on standard MPUs or DSPs. In some embodiments, the PCC decoder 118 may also be interfaced with a GPU to parallelize the operations of the PCC decoder 118.

In operation, the electronic device 102 may be configured to acquire the reference point cloud 112 of an object. In accordance with an embodiment, the reference point cloud may be an uncompressed point cloud of the object. The reference point cloud 112 may represent the geometry of the object using a plurality of 3D points. In some embodiments, the electronic device 102 may generate the reference point cloud 112 based on a plurality of images of the object captured from different viewpoints and depth information associated with the object. The plurality of images and the depth information may be obtained via one or more image capture devices and depth sensors associated with the electronic device 102.

The electronic device 102 may be further configured to encode the reference point cloud 112 to generate the encoded point cloud data 114 (i.e., a coded bitstream). The electronic device 102 may locally decode the encoded point cloud data 114 to generate the test point cloud data 116. The test point cloud 116 may be generated to determine whether reconstruction of the reference point cloud 112 (or decoding of the encoded point cloud data 114) by a PCC decoder (for example, the PCC decoder 118) may lead to generation of geometry reconstruction artifacts in a reconstructed point cloud. The electronic device 102 may predict that the PCC decoder 118 may detect geometry reconstruction artifacts at one or more regions in the reconstructed point cloud. The prediction may be based on detection of geometry reconstruction artifacts in the test point cloud 116 at one or more regions of the test point cloud 116.

The electronic device 102 may be further configured to generate a first local density map for the 3D points of the reference point cloud 112. The first local density map may include an estimate of local density for each 3D point of the reference point cloud 112. The local density at a 3D point may be indicative of number of 3D points in a neighborhood of the 3D point of the reference point cloud 112. The local density at a 3D point may be estimated further based on a volume of a region of the reference point cloud 112 that forms the neighborhood of the 3D point. In accordance with an embodiment, the electronic device 102 may determine a count (or number) of 3D points in the reference point cloud 112 and dimensions of a structure (for example, a cubical region) that may include (or enclose) all 3D points of the reference point cloud 112. The electronic device 102 may further determine a radius (R_{ref}) based on the number of 3D points of the reference point cloud 112 and the dimensions of the structure. The electronic device 102 may also determine a volume (V_{ref}) of a sphere of the determined radius (i.e., R_{ref}).

Once the volume (V_{ref}) of the sphere is determined, the electronic device 102 may determine, for each 3D point of the reference point cloud 112, a number of 3D points in the neighborhood of the corresponding 3D point. The neighborhood of a 3D point of the reference point cloud 112 may include one or more points that are included in the sphere of radius R_{ref}. The center (i.e., origin) of the sphere may be the location of the 3D point in the reference point cloud 112. The number of 3D points in the neighborhood of each 3D point of the reference point cloud 112 may be determined based on the reference point cloud 112, R_{ref}, and the location of the corresponding 3D point of the reference point cloud 112. The electronic device 102 may further estimate the local density of each 3D point of the reference point cloud 112 based on the number of 3D points in the neighborhood of the corresponding 3D point and the volume, V_{ref}. The electronic device 102 may estimate the first local density map based on the estimated local density of each of the 3D points of the reference point cloud 112. Similarly, the electronic device 102 may generate a second local density map for 3D points of the test point cloud 116. The second local density map may include an estimate of local density at each location of the test point cloud 116 that corresponds to a location of a 3D point of the reference point cloud 112. In accordance with an embodiment, the electronic device 102 may determine a count (or number) of 3D points in the test point cloud 116 and dimensions of a structure (for example, a cubical region) that may include (or enclose) all 3D points of the test point cloud 116. The electronic device 102 may further determine a radius (Rₜₑₛₜ) based on the number of 3D points and the dimensions of the structure. The electronic device 102 may also determine a volume (Vₜₑₛₜ) of a sphere of the determined radius (i.e., Rₜₑₛₜ).

For each 3D point of the reference point cloud 112, the electronic device 102 may determine a number of 3D points in a neighborhood of a location in the test point cloud 116 that corresponds to a location of the 3D point in the reference point cloud 112. The neighborhood of a location of the test point cloud 116, corresponding to a location of a 3D point of the reference point cloud 112, may include one or more points of the test point cloud 116. Such points may be included in the sphere of radius Rₜₑₛₜ. The center (i.e., origin) of the sphere may be the location of the test point cloud 116. The number of 3D points in the neighborhood of the location (that corresponds to a location of a 3D point of the reference point cloud 112) in the test point cloud 116 may be determined based on the test point cloud 116, Rₜₑₛₜ, and the location (i.e., coordinates) of the 3D point of the reference point cloud 112.

The electronic device 102 may further estimate the local density at each location (that corresponds to a location of a 3D point of the reference point cloud 112) in the test point cloud 116 based on the number of 3D points in the neighborhood of the corresponding location in the test point cloud 116 and Vₜₑₛₜ. The electronic device 102 may further estimate a second local density map based on the estimated local density at each location of the test point cloud 116 that corresponds to a location of a 3D point of the reference point cloud 112.

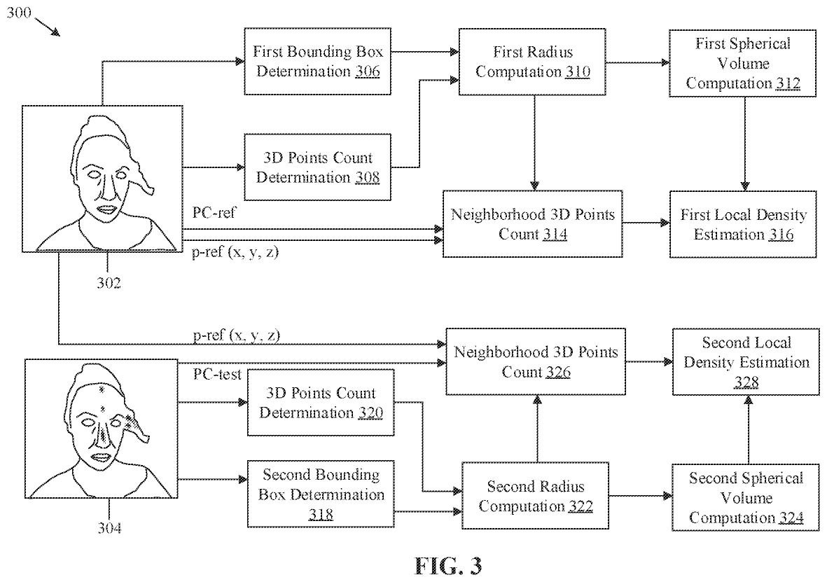

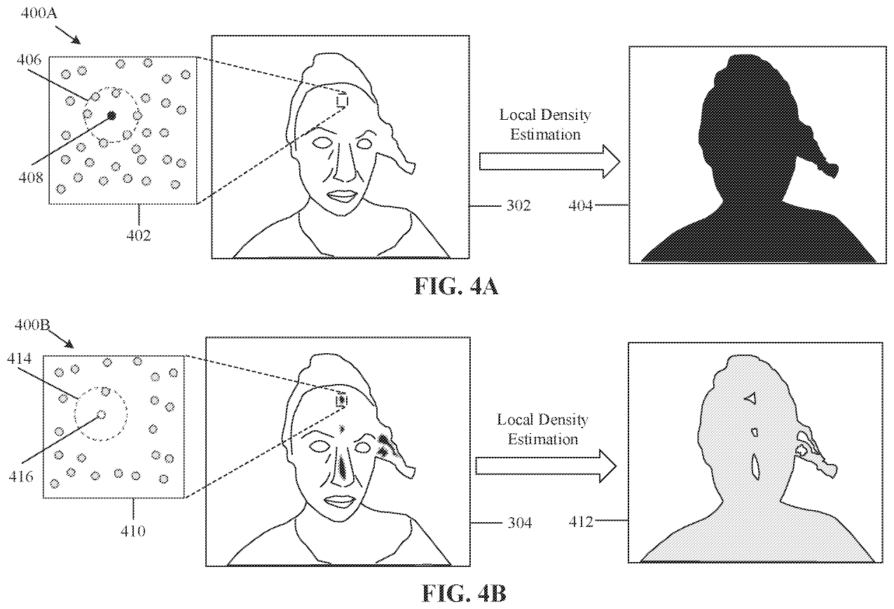

In accordance with an embodiment, the first local density map may represent a homogenous local density of the 3D points of the reference point cloud 112. The first local density map may be homogenous as the estimated local density of the 3D points of the reference point cloud is similar. Similarly, the second local density map may represent a heterogeneous local density of the 3D points of the test point cloud 116. The second local density at each location of the test point cloud 116 may vary based on a corresponding location of a 3D point in the reference point cloud 112, and a number of 3D points of the test point cloud 116 that lie in the neighborhood of the location in the test point cloud 116. Details of generation of an example first local density map and an example second local density map are described in FIG. 3, FIG. 4A, and FIG. 4B.

The electronic device 102 may be further configured to generate a final density map based on a comparison between the first local density map and the second local density map. By way of example, and not limitation, the final density map may be referred to as a difference density map that may be generated based on local density differences between the first local density map and the second local density map. Specifically, for each 3D point of the reference point cloud 112, a local density difference value may be determined based on a difference between a local density at a corresponding 3D point in the reference point cloud 112 and a local density of a location of the corresponding 3D point in the test point cloud 116. The final density map may comprise of local density difference values associated with each of the 3D points of the reference point cloud 112.

In accordance with an embodiment, the electronic device 102 may detect geometry reconstruction artifacts in the test point cloud 116 based on the local density difference values in the final density map. In accordance with an embodiment, the geometry reconstruction artifacts may correspond to holes in the test point cloud 116. For 3D points that correspond to a first region of the final density map, the final density map may indicate that local density difference values for the first region are greater than a density threshold. For 3D points that correspond to a second region of the final density map, the final density map may indicate that local density difference values for the second region are less than the density threshold.

The electronic device 102 may detect a presence of the geometry reconstruction artifacts (for example, holes) in a region of the test point cloud 116 that corresponds to the first region of the final density map (since the local density differences are higher in the first region compared to other regions of the final density map). Higher local density difference values may indicate larger differences in local density between corresponding regions of the reference point cloud 112 and the test point cloud 116. The higher local density difference may also indicate loss of 3D points in the test point cloud 116 in the generation of the test point cloud 116.

The electronic device 102 may be further configured to generate supplementary information based on the final density map. The supplementary information may include missing points data corresponding to regions of the test point cloud 116 that include the geometry reconstruction artifacts (for example, holes). The missing points data may include 3D points of the reference point cloud 112 that may be missing (e.g., missing 3D points for holes in a point cloud) from the test point cloud 116 due to losses introduced during decoding and/or reconstruction operations. The electronic device 102 may determine such points as missing point data from the test point cloud 116 based on the reference point cloud 112 and the final density map.

In accordance with an embodiment, the electronic device 102 may obtain a 3D mask from the final density map, based on a threshold value. The 3D mask may be used to determine the missing point data. The threshold value may correspond to a percentage (for example, 5%) of voxels of the reference point cloud 112 that may be selectable as representative of the geometry reconstruction artifacts in the reference point cloud 112.

In accordance with another embodiment, the electronic device 102 may obtain a 3D mask from the final density map, based on a threshold value (for example, the density threshold) to determine the missing points data. The threshold value may correspond to a local density difference value. The local density difference values associated with a percentage (for example 5%) of 3D points (for example, a first set of 3D points) of the reference point cloud 112 may be greater than the threshold value. The local density difference values associated with the first set of 3D points may constitute a region (for example, the first region) of the final density map. Similarly, the local density difference values associated with a percentage (for example 95%) of 3D points (i.e., a second set of 3D points) of the reference point cloud 112 may be less than the threshold value. The local density difference values associated with the second set of 3D points may constitute another region (for example, the second region) of the final density map.

In accordance with an embodiment, the 3D mask may be obtained by transforming the local density difference values associated with the first set of 3D points (i.e., the first region of the final density map) to ‘1’ and the local density difference values associated with the second set of 3D points (i.e., the second region of the final density map) to ‘0’. The electronic device 102 may be further configured to generate the missing points data based on application of the 3D mask on the reference point cloud 112. The application of the 3D mask may result in determination of locations (i.e., or coordinates) of the first set of 3D points in the reference point cloud 112. The locations of the first set of 3D points and other point cloud data (i.e., geometrical information and attribute information) associated with each of the first set of 3D points may constitute the missing points data or the supplementary information.

In accordance with an embodiment, the supplementary information may include one or more descriptors for the regions of the test point cloud 116 that include the geometry reconstruction artifacts. By way of example, and not limitation, each of such descriptors may be a volume descriptor that indicates one or more parameters of a polyhedron structure. For example, the polyhedron structure may be an ellipsoid and the volume descriptor may be indicative of the volume of the ellipsoid. The polyhedron structure may correspond to one of the regions of the test point cloud 116 that include the geometry reconstruction artifacts (i.e., the holes). For example, the first region of the final density map may correspond to a region of the test point cloud 116 that includes holes. Therefore, the polyhedron structure (i.e., the ellipsoid) may be indicative of the first region of the final density map (for which the local density differences between the first local density map and the second local density map is greater than the threshold density). The supplementary information may include the volume of the ellipsoid and regions of the test point cloud 116 to which the ellipsoid corresponds.

The electronic device 102 may be further configured to compute a set of quality metrics that define the quality of the test point cloud 116 (i.e., a quality of reconstruction of the reference point cloud 112). The set of quality metrics may quantify the presence of geometry reconstruction artifacts (for example, holes) in the test point cloud 116. The quality of the generated test point cloud 116 may be defined based on one or more of a first metric, a second metric, and a third metric. Each of the three metrics may be computed based on the final density map. The supplementary information may include the first metric, the second metric, and the third metric.

In accordance with an embodiment, the electronic device 102 may be configured to compute the first quality metric as a ratio between a number of points in the regions of the test point cloud 116 that include the geometry reconstruction artifacts and a total number of the 3D points of the reference point cloud 112. The number of points in the regions of the test point cloud 116 may be determined based on the final density map. The regions (e.g., the first region) of the final density map, where local density difference values are greater than the threshold value (i.e., the density threshold) may be representative of holes. It should be noted that one or more regions (apart from the first region) of the test point cloud 116 may include holes. However, presence of holes in such regions of the test point cloud 116 may be due to presence of holes in corresponding regions of the reference point cloud 112. Such holes in the reference point cloud 112 may be natural holes ((e.g., a mouth hole of a 3D head scan) in shape or geometry features of a 3D object or 3D scan artifacts (e.g., holes associated with photogrammetric reconstruction). Holes in such regions of the test point cloud 116 may not be used for computation of the first quality metric.

In accordance with an embodiment, the electronic device 102 may determine the number (and location) of the first set of 3D points based on the missing points data (i.e., data generated based on application of the 3D mask on the reference point cloud 112). The locations of the first set of 3D points may correspond to the regions of the test point cloud 116 that include the geometry reconstruction artifacts (i.e., holes). Once the number of 3D points in the first set of 3D points is determined, the first metric may be computed as the ratio of the number of 3D points in the first set of 3D points and the total number of the 3D points of the reference point cloud 112.

In accordance with an embodiment, the electronic device 102 may be configured to compute the second quality metric that is proportional to a reciprocal of a number of the one or more descriptors for which a volume parameter is above a volume threshold. The second quality metric may be represented using equation (1), as follows:

$$Q = \frac{f ( p , q , r , Z )}{N + 1} \qquad ( 1 )$$

where, “Q” represents the second quality metric, “f” is a function that may be “1” in its simplest form (i.e., f(p, q, r, Z)=1), a global density of the reference point cloud 112, or a function that may be based on dimensions of a bounding box of the reference point cloud 112 (that includes all 3D points of the reference point cloud 112), and “N” specifies the number of the one or more descriptors for which a volume parameter is above a volume threshold.

If the bounding box of the reference point cloud 112 is cubical and the dimensions of the bounding box are represented using “p”, “q”, and “r”, then the count of the 3D points of the reference point cloud 112 may be represented as “Z”. The function “f” may be represented using equation (2), as follows:

$$f ( p , q , r , Z ) = \frac{Z}{p \times q \times r} \qquad ( 2 )$$

In accordance with an embodiment, the global density of the reference point cloud 112 may be directly proportional to “Q” and a count of holes may be inversely proportional to “Q”. In such a case, the global density may correspond to a median of density distribution or a median of local densities at the 3D points of the reference point cloud 112.

If there are no holes in the test point cloud 116, then “N” will be equal to “0” and “Q” will be “1” (i.e., best quality). A descriptor may be a volume descriptor that indicates a parameter (for example, volume) of a polyhedron structure such as an ellipsoid. For example, three regions of the test point cloud that 116 may include holes. Such regions may correspond to three ellipsoids (i.e., a first ellipsoid, a second ellipsoid, and a third ellipsoid). The final density map may include a second region and a third region (in addition to the first region) where local density differences between the first local density map and the second local density map is more than the threshold density. The three regions of the test point cloud 116 may correspond to the three regions of the final density map and the three ellipsoids may be used to represent the three regions of the final density map. The volume of the first region of the final density map may correspond to the volume of the first ellipsoid. Similarly, volumes of the second and third regions of the final density map may correspond to respective volumes of the second ellipsoid and the third ellipsoid.

In accordance with an embodiment, the electronic device 102 may be configured to determine the volume of each of the three ellipsoids and compare the volume with a volume threshold. The second quality metric may be computed based on the comparison. For example, the second quality metric may be computed as ½ if the volume of one of the three ellipsoids is above the volume threshold (i.e., N=1). The second quality metric may be computed as ⅓ (i.e., N=2) if the volume of two of the three ellipsoids is above the volume threshold. The second quality metric may be computed as ¼ (i.e., N=3) if the volume of all the ellipsoids is above the volume threshold.

In accordance with an embodiment, the electronic device 102 may be configured to compute the third quality metric as a weighted sum of the first quality metric and the second quality metric.

The electronic device 102 may be further configured to signal the supplementary information to the PCC decoder 118. In accordance with an embodiment, the electronic device 102 may signal the encoded point cloud data 114 as a coded bitstream along with the supplementary information. The PCC decoder 118 may receive the encoded point cloud data 114. The encoded point cloud data 114 may be decoded to generate a reconstructed point cloud. The reconstructed point cloud may include geometry reconstruction artifacts in one or more regions that correspond to one or more regions of the test point cloud 116 (i.e., region(s) that include the geometry reconstruction artifacts). The supplementary information may be used to process the reconstructed point cloud and generate a final point cloud that is free of geometry reconstruction artifacts (such as holes) or includes minimum number of the geometry reconstruction artifacts.

In accordance with an embodiment, the electronic device 102 may be configured to determine a number of holes in the test point cloud 116 based on the final density map. The number of holes in the test point cloud 116 may be determined based on a number of 3D points for which local density difference values (determined based on the final density map) is greater than the threshold value (i.e., the density threshold). At encoding stage, the electronic device 102 may adjust a number of bits per point (i.e., a 3D point) until the number of holes in the test point cloud 116 is a minimum. The number of bits per point may to be used to encode reference point cloud 112 and the adjustment of the number of bits per point may enable an appropriate selection of a rate-distortion cost. The number of holes in the test point cloud 116 may be minimum if number of bits to be used to encode 3D points or blocks of the reference point cloud 112 results in a lowest possible rate rate-distortion cost. Once the selection of the number of bits per point used is optimal, difference density values for certain regions of the final density map (for which local density differences between the first local density map and the second local density map is more than the threshold density) may reduce significantly.

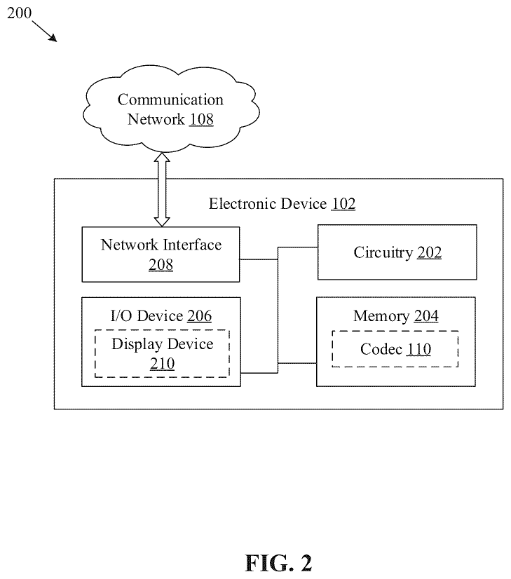

FIG. 2 is a block diagram that illustrates an exemplary electronic device of FIG. 1, in accordance with an embodiment of the disclosure. FIG. 2 is explained in conjunction with elements from FIG. 1. With reference to FIG. 2, there is shown a block diagram 200 of the electronic device 102. The electronic device 102 may include circuitry 202, a memory 204, an input/output (I/O) device 206, and a network interface 208. In at least one embodiment, the memory 204 may include the codec 110. In at least one embodiment, the I/O device 206 may also include a display device 210. The circuitry 202 may be communicatively coupled to the memory 204, the I/O device 206, and the network interface 208, through wired or wireless communication of the electronic device 102.

The circuitry 202 may include suitable logic, circuitry, and interfaces that may be configured to execute program instructions associated with different operations to be executed by the electronic device 102. The circuitry 202 may include one or more specialized processing units, which may be implemented as an integrated processor or a cluster of processors that perform the functions of the one or more specialized processing units, collectively. The circuitry 202 may be implemented based on a number of processor technologies known in the art. Examples of implementations of the circuitry 202 may be an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other computing circuits.

The memory 204 may include suitable logic, circuitry, and/or interfaces that may be configured to store instructions executable by the circuitry 202. The memory 204 may be configured to store operating systems and associated applications. The memory 204 may be further configured to store the acquired reference point cloud 112 of the object, the encoded point cloud data 114 and the test point cloud 116. The memory 204 may be further configured to store the first local density map, the second local density map, the final density map, and the supplementary information. In at least one embodiment, the memory 204 may include the codec 110 that may be implemented as a combination of programmable instructions stored in the memory 204 and logical units (or programmable logic units) on a hardware circuitry of the electronic device 102. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive a user input. The I/O device 206 may be further configured to provide an output in response to the user input. The I/O device 206 may include various input and output devices, which may be configured to communicate with the circuitry 202. Examples of the input devices may include, but are not limited to, a touch screen, a keyboard, a mouse, a joystick, and/or a microphone. Examples of the output devices may include, but are not limited to, the display device 210.

The network interface 208 may include suitable logic, circuitry, interfaces, and/or code that may be configured to establish a communication between the electronic device 102, the external device 104, and the server 106, via the communication network 108. The network interface 208 may be implemented by use of various known technologies to support wired or wireless communication of the electronic device 102 with the communication network 108. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The network interface 208 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VOIP), light fidelity (Li-Fi), Wi-MAX, a protocol for email, instant messaging, and/or Short Message Service (SMS).

The display device 210 may include suitable logic, circuitry, interfaces, and/or code that may be configured to render the reference point cloud 112 and the test point cloud 116 onto a display screen of the display device 210. In accordance with an embodiment, the display device 210 may include a touch screen to receive the user input. The display device 210 may be realized through several known technologies such as, but not limited to, a Liquid Crystal Display (LCD) display, a Light Emitting Diode (LED) display, a plasma display, and/or an Organic LED (OLED) display technology, and/or other display technologies. In accordance with an embodiment, the display device 210 may refer to a display screen of smart-glass device, a 3D display, a see-through display, a projection-based display, an electro-chromic display, and/or a transparent display.

The functions or operations executed by the electronic device 102, as described in FIG. 1, may be performed by the circuitry 202. Operations executed by the circuitry 202 are described in detail, for example, in FIGS. 3, 4, 5, 6, 7, 8, and 9.

FIG. 3 is a diagram that illustrates an exemplary processing pipeline for estimation of local density maps for 3D points of a reference point cloud and a test point cloud, in accordance with an embodiment of the disclosure. FIG. 3 is explained in conjunction with elements from FIG. 1 and FIG. 2. With reference to FIG. 3, there is shown an exemplary processing pipeline 300 for estimation of local density maps for a reference point cloud 302 and a test point cloud 304. In the processing pipeline 300, there is shown a sequence of operations that may start from 306 and end at 328. The sequence of operations may be executed by the circuitry 202 of the electronic device 102.

The reference point cloud 302 may be an exemplary point cloud that may be same as or similar to the reference point cloud 112 of FIG. 1. Similarly, the test point cloud 304 may be an exemplary point cloud that may be same as or similar to the test point cloud 116 of FIG. 1. The reference point cloud 302 may be an uncompressed point cloud of an object such as a human head. The circuitry 202 may generate the test point cloud 304 based on encoded point cloud data (obtained after encoding the reference point cloud 302).

At 306, a first bounding box for the reference point cloud (PC_{ref}) 302 may be determined. In at least one embodiment, the circuitry 202 may be configured to determine the first bounding box for the reference point cloud 302. The first bounding box may include all 3D points of the reference point cloud 302. By way of example, and not limitation, the first bounding box may correspond to a cubical region. The circuitry 202 may be configured to determine the dimensions (i.e., length, breadth, and height) of the cubical region such that the cubical region includes (or encloses) all 3D points of the reference point cloud 302.

At 308, a first count (i.e., a first number) of 3D points of the reference point cloud (PC_{ref}) 302 may be determined. In at least one embodiment, the circuitry 202 may be configured to determine the first number of 3D points in the reference point cloud 302.

At 310, a first radius may be computed. In at least one embodiment, the circuitry 202 may be configured to compute the first radius to be used to sample the 3D points of the reference point cloud 302. The first radius may be computed based on the first bounding box and the first number of 3D points in the reference point cloud 302. The circuitry 202 may determine a surface of the reference point cloud 302 based on the dimensions of the first bounding box. For example, a length “a”, a breadth “b”, and a height “c” may be the dimensions of the first bounding box. The surface of the reference point cloud 302 “S_{R}” may be determined as a square of the cube root of the volume of the first bounding box. The first bounding box may include a plurality of surfaces of equal dimensions that may be determined based on the dimensions of the first bounding box (i.e., the cubical region). For example, the volume of the first bounding box may be determined as (a×b×c). Thus, “SR” may be determined using equation (3), as follows:

$${S}_{R} = {\sqrt[3]{a \times b \times c}}^{2} \qquad ( 3 )$$

Once the plurality of surfaces is determined, the circuitry 202 may compute the first radius (R₁) based on the number of 3D points (i.e., “N_{points-reference}”) in the reference point cloud 302 and the number of 3D points (“N_{R}”) within each surface of the reference point cloud 302. Thus, R₁ may be determined using equation (4), as follows:

$${R}_{1} = \sqrt[2]{{N}_{R} \times {S}_{R} / {N}_{points - reference}} \qquad ( 4 )$$

At 312, a first spherical volume may be determined. In at least one embodiment, the circuitry 202 may be configured to determine the first spherical volume based on the first radius. The first volume may be expressed using equation (5), as follows:

$$First Volume = \frac{4}{3} {π ( First Radius )}^{3} \qquad ( 5 )$$

At 314, a first count (i.e., a first number) of 3D points in a neighborhood of each 3D point of the reference point cloud 302 may be determined. In at least one embodiment, the circuitry 202 may be configured to determine, from the 3D points of the reference point cloud 302, the first number of 3D points in the neighborhood of each 3D point of the reference point cloud 302. The neighborhood of each 3D point of the reference point cloud 302 may include a plurality of points that are included in a first sphere of the first radius and the first spherical volume. The first number of 3D points (i.e., the plurality of points) in the neighborhood of each 3D point of the reference point cloud 302 may be determined based on a location (i.e., coordinates x, y, and z) of a corresponding 3D point (p_{ref}) of the reference point cloud 302, the reference point cloud 302, and the first radius. The center (or origin) of the first sphere may be the location of the corresponding 3D point (i.e., p_{ref} (x, y, z)) of the reference point cloud 112.

At 316, a first local density for each 3D point of the reference point cloud 302 may be estimated. In at least one embodiment, the circuitry 202 may be configured to estimate the first local density for each 3D point of the reference point cloud 302 based on the first spherical volume and the first number of 3D points in the neighborhood of the corresponding 3D point (for example, p_{ref}). Specifically, the first local density for the 3D point p_{ref} may be estimated as a ratio of the first number of 3D points in the neighborhood of the 3D point p_{ref} and the first spherical volume. The circuitry 202 may be further configured to generate a first local density map based on the first local density for each 3D point of the reference point cloud 302.

At 318, a second bounding box for the test point cloud (PCₜₑₛₜ) 304 may be determined. In at least one embodiment, the circuitry 202 may be configured to determine the second bounding box for the test point cloud 304. By way of example, and not limitation, the second bounding box may be a cubical region such that the cubical region includes (or encloses) all 3D points of the test point cloud 304.

At 320, a second count (i.e., second number) of 3D points of the test point cloud (PCₜₑₛₜ) 304 may be determined. In at least one embodiment, the circuitry 202 may be configured to determine the second number of 3D points in the test point cloud 304.

At 322, a second radius may be computed. In at least one embodiment, the circuitry 202 may be configured to compute the second radius to be used to sample the 3D points of the test point cloud 304. The second radius may be computed based on the second bounding box and the second number of 3D points in the test point cloud 304. The computation of the second radius is similar to the computation of the first radius. For example, a length “x”, a breadth “y”, and a height “z” may be the dimensions of the second bounding box. The surface of the test point cloud 304 “ST” may be determined as a square of the cube root of the volume of the second bounding box. The second bounding box may include a plurality of surfaces of equal dimensions that may be determined based on the dimensions of the second bounding box (i.e., the cubical region). For example, the volume of the second bounding box may be determined as (x×y×z). Thus, “ST” may be determined using equation (6), as follows:

$${S}_{T} = {\sqrt[3]{x \times y \times z}}^{2} \qquad ( 6 )$$

Once the plurality of surfaces is determined, the circuitry 202 may compute the second radius (R₂) based on the number of 3D points (i.e., “Nₚₒᵢₙₜₛ₋ₜₑₛₜ”) in the test point cloud 304 and the number of 3D points (“N_{T}”) within each surface of the test point cloud 304. Thus, R₂ may be determined using equation (7), as follows:

$${R}_{2} = \sqrt[2]{{N}_{T} \times {S}_{T} / {N}_{points - test}} \qquad ( 7 )$$

At 324, a second spherical volume may be computed. In at least one embodiment, the circuitry 202 may be configured to compute the second spherical volume based on the second radius. The second volume may be expressed using equation (8), as follows:

$$Second Volume = \frac{4}{3} {π ( Second Radius )}^{3} \qquad ( 8 )$$

At 326, a second count (i.e., a second number) of 3D points in a neighborhood of each location (that corresponds to a location of a 3D point of the reference point cloud 302) in the test point cloud 304 may be determined. In at least one embodiment, the circuitry 202 may be configured to determine, from the 3D points of the test point cloud 304, the second number of 3D points in the neighborhood of each location in the test point cloud 304. The neighborhood of each location (that corresponds to a location of a 3D point of the reference point cloud 302) in the test point cloud 304 may include a plurality of points of the test point cloud 304. Such points of the test point cloud 304 may be located in a second sphere of the second radius and the second spherical volume. The second number of 3D points (i.e., the plurality of points) in the neighborhood of each location in the test point cloud 304 may be determined based on coordinates (i.e., x, y, and z coordinate values) of a corresponding location of the reference point cloud 302 that includes a 3D point, the test point cloud 304, and the second radius. The center (or origin) of the second sphere may be the location in the test point cloud 304.

At 328, a second local density at each location of the test point cloud 304, that corresponds to a location of a 3D point of the reference point cloud 302, may be estimated. In at least one embodiment, the circuitry 202 may be configured to estimate the second local density at each location of the test point cloud 304 based on the second spherical volume and the second number of 3D points in the neighborhood of the corresponding location of the test point cloud 304. The second local density at a location in the test point cloud 304 may be estimated as a ratio of the second number of 3D points in the neighborhood of the location and the second spherical volume. The circuitry 202 may be further configured to generate a second local density map based on the second local density at location in the test point cloud 304.

FIG. 4A is a diagram that illustrates an exemplary scenario for generation of a first local density map for 3D points of a reference point cloud, in accordance with an embodiment of the disclosure. FIG. 4A is explained in conjunction with elements from FIG. 1, FIG. 2, and FIG. 3. With reference to FIG. 4A, there is shown an exemplary scenario 400A. In exemplary scenario 400A, there is shown the reference point cloud 302 of FIG. 3 and a set of 3D points of a region 402 of the reference point cloud 302. There is further shown an exemplary first local density map 404.

The circuitry 202 may be configured to generate the first local density map 404 for 3D points of the reference point cloud 302. The first local density map 404 may be generated based on the first local density for each 3D point of the reference point cloud 302. In accordance with an embodiment, the circuitry 202 may be configured to compute a first radius of a first sphere 406 based on the first number of 3D points in the reference point cloud 302. The circuitry 202 may be also configured to compute a first volume of the first sphere 406 based on the first radius of the first sphere 406.

For a 3D point 408, the first local density may be estimated based on the first volume of a first sphere 406 and a first number of 3D points in neighborhood of the 3D point 408. The center of the first sphere 406 may correspond to the location (i.e., coordinates) of the 3D point 408 and the neighborhood of the 3D point 408 may correspond to a region enclosed by the first sphere 406. The first number of 3D points in neighborhood of the 3D point 408 may be determined based on the location (i.e., coordinates) of the 3D point 408, the reference point cloud 302, and the first radius of the first sphere 406.

FIG. 4B is a diagram that illustrates an exemplary scenario for generation of a second local density map for 3D points of a test point cloud, in accordance with an embodiment of the disclosure. FIG. 4B is explained in conjunction with elements from FIG. 1, FIG. 2, FIG. 3, and FIG. 4A. With reference to FIG. 4B, there is shown an exemplary scenario 400B. In exemplary scenario 400B, there is shown the test point cloud 304 of FIG. 3 and a set of 3D points of a region 410 of the test point cloud 304. The region 410 of the test point cloud 304 may correspond to the region 402 of the reference point cloud 302. The region 410 of the test point cloud 304 may include geometry reconstruction artifacts (for example, holes). Therefore, a number of 3D points in a region 410 of the test point cloud 304 may be lesser than the number of 3D points in the region 402 of the reference point cloud 302. There is further shown an exemplary second local density map 412 that may be generated for 3D points of the test point cloud 304.

The circuitry 202 may be configured to generate the second local density map 412 based on the second local density at each location of the test point cloud 304 that corresponds to a location of a 3D point of the reference point cloud 302. The circuitry 202 may obtain locations of the 3D points of the reference point cloud 302 and generate the second local density map 412 based on the obtained locations. In accordance with an embodiment, the circuitry 202 may be configured to compute a second radius of a second sphere 414 based on the second number of 3D points in the test point cloud 304. The circuitry 202 may further compute a second volume of the second sphere 414 based on the second radius of the second sphere 414.

In accordance with an embodiment, the circuitry 202 may be configured to estimate the second local density at a location 416 (that corresponds to the location of the 3D point 408 of the reference point cloud 302) in the test point cloud 304 based on the second volume of the second sphere 414 and a second number of 3D points in neighborhood of the location 416 in the test point cloud 304. The center of the second sphere 414 may correspond to the location 416 and the neighborhood of the location 416 may correspond to a region enclosed by the second sphere 414. The second number of 3D points in neighborhood of the location 416 may be determined based on coordinates of the location of the 3D point 408 (in the reference point cloud 302), the test point cloud 304, and the second radius of the second sphere 414.

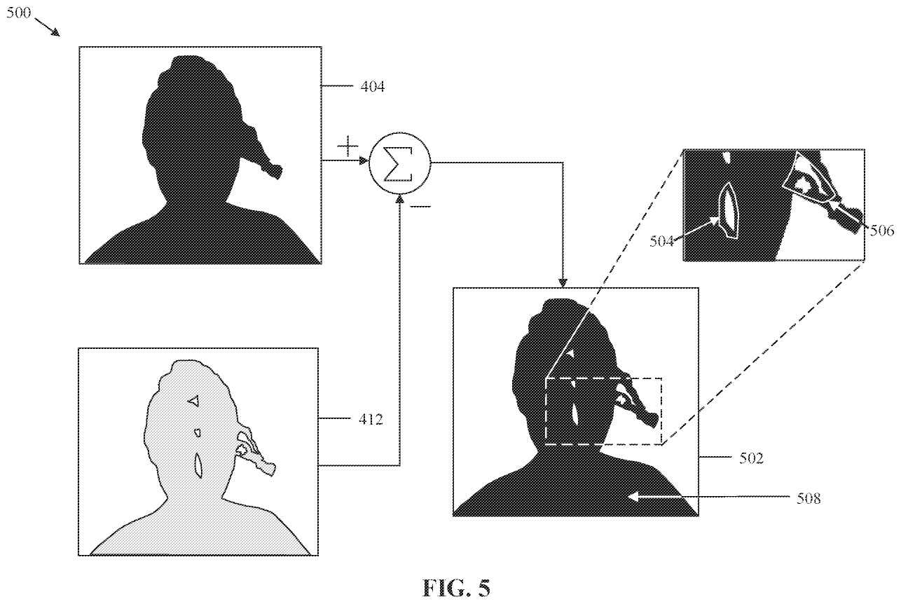

FIG. 5 is a diagram that illustrates an exemplary scenario for generation of a final density map based on local density maps associated with 3D points of a reference point cloud and a test point cloud, in accordance with an embodiment of the disclosure. FIG. 5 is explained in conjunction with elements from FIG. 1, FIG. 2, FIG. 3, FIG. 4A, and FIG. 4B. With reference to FIG. 5, there is shown an exemplary scenario 500. In the exemplary scenario 500, there is shown an exemplary final density map 502 that may be generated based on the first local density map 404 and the second local density map 412. The final density map 502 may be referred to as a difference density map since the final density map 502 is generated based on a difference between the first local density map 404 and the second local density map 412.

The circuitry 202 may be configured to generate the final density map 502 based on a comparison between the first local density map 404 and the second local density map 412. The comparison may include determination of a difference between the first local density map 404 and the second local density map 412 to generate the final density map 502. In accordance with an embodiment, the final density map 502 may include a first region (for example, a region 504 and a region 506) for which local density differences between the first local density map 404 and the second local density map 412 are more than that for a second region (for example, a region 508) of the final density map 502. The local density differences between the first local density map 404 and the second local density map 412 may correspond to differences between the first local density at locations of each 3D point of the reference point cloud 302 and a second local density at locations in the test point cloud 304 that correspond to the locations of each 3D point of the reference point cloud 302. The difference between the first local density and the second local density at locations associated with each 3D point may be referred to as a local density difference value. Thus, the final density map 502 may include local density difference values associated with the locations of each 3D point of the reference point cloud 302. The local density difference values associated with the locations of a first set of 3D points that constitute the first region (i.e., the regions 504 and 506) may be greater than a density threshold, while the local density difference values associated with the locations of a second set of 3D points that constitute the second region 508 may be less than the density threshold. Higher local density difference values for certain regions of the final density map 502 may indicate a low-quality reconstruction of corresponding regions of the test point cloud 304 and presence of reconstruction artifacts such as holes in such regions. Similarly, lower local density difference values for certain regions of the final density map 502 may indicate a high-quality reconstruction of corresponding regions of the test point cloud 304 and absence of reconstruction artifacts such as holes in such regions. The circuitry 202 may be configured to detect geometry reconstruction artifacts in the first region (i.e., the regions 504 and 506) of the final density map 502 based on variations in the local density difference values and comparison of such values with a density threshold.

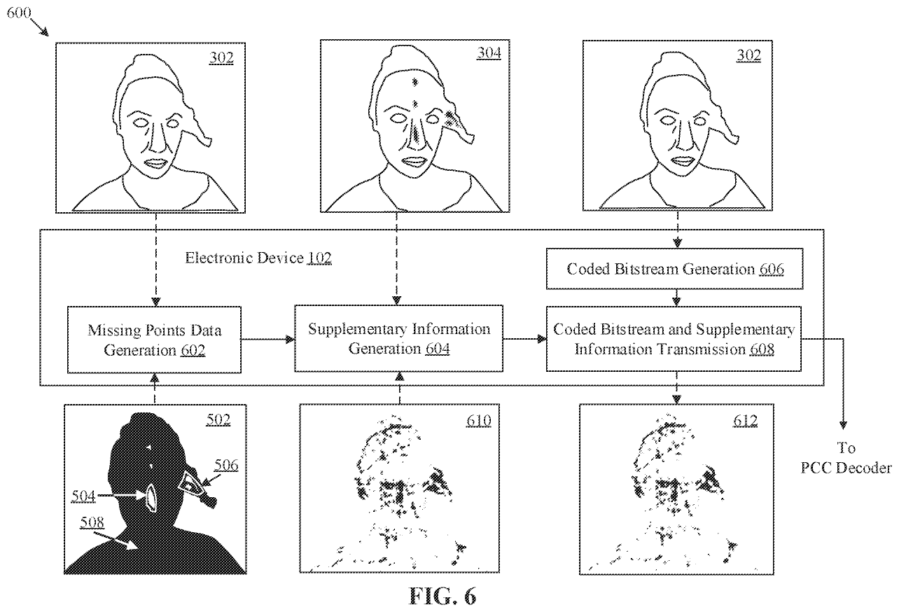

FIG. 6 is a diagram that illustrates an exemplary processing pipeline for generation and signaling of supplementary information to a Point Cloud Compression (PCC) decoder, in accordance with an embodiment of the disclosure. FIG. 6 is explained in conjunction with elements from FIG. 1, FIG. 2, FIG. 3, FIG. 4A, FIG. 4B, and FIG. 5. With reference to FIG. 6, there is shown an exemplary processing pipeline 600 for generation of supplementary information and signaling of the supplementary information. In the processing pipeline 600, there is shown a sequence of operations that may start from 602 and end at 608. The sequence of operations may be executed by the circuitry 202 of the electronic device 102. The supplementary information may be generated based on the reference point cloud 302, the test point cloud 304 of FIG. 3, and the final density map 502 of FIG. 5. The supplementary information may include missing points data corresponding to regions of the test point cloud 304 which include geometry reconstruction artifacts such as holes.

At 602, missing points data 610 may be generated. In at least one embodiment, the circuitry 202 may be configured to generate missing points data 610 based on the reference point cloud 302 and the final density map 502. The missing points data 610 may include 3D points of the reference point cloud 302 that may be missing from the test point cloud 304 due to decoding or reconstruction issues. The missing points data 610 may correspond to regions of the test point cloud 304 that include holes (i.e., holes that only appear after reconstruction).

In accordance with an embodiment, the circuitry 202 may be configured to obtain a 3D mask from the final density map 502, based on a threshold value (for example, the density threshold) to determine the missing point data 610. The threshold value may correspond to a percentage (for example, 5%) of voxels (or 3D points) of the reference point cloud 302 that may be selectable as representative of the geometry reconstruction artifacts in the reference point cloud 302. In some embodiments, the threshold value may correspond to the density threshold used for detection of the geometry reconstruction artifacts. The threshold value (i.e., the density threshold) may correspond to a local density difference value and may enable selection of a percentage of 3D points (for example, a first set of 3D points of the first number of the 3D points) of the reference point cloud 302. The circuitry 202 may select 3D points from the first number of the 3D points of the reference point cloud 302 based on a comparison of local density difference values (associated with the locations of each 3D point of the reference point cloud 302) and the threshold value. The local density difference values associated with selected 3D points (i.e., the first set of 3D points) may be greater than the threshold value (i.e., the density threshold) and may be greater compared to that for other 3D points (i.e., the second set of 3D points).

The circuitry 202 may be further configured to transform local density difference values associated with the selected 3D points to ‘1’ and local density difference values associated with other 3D points of the reference point cloud 302 to ‘0’. Thus, the 3D mask may be obtained based on transformation of the first region (i.e., the regions 504 and 506) of the final density map 502 to ‘1’, and the second region 508 of the final density map 502 to ‘0’. Once the 3D mask is obtained, the circuitry 202 may generate the missing points data 610 based on application of the 3D mask on the reference point cloud 302. The missing points data 610 may include locations (or coordinates) of the selected 3D points (i.e., the first set of 3D points) in the reference point cloud 302 and other point cloud data (i.e., geometrical information and attribute information) associated with the first set of 3D points.

At 604, the supplementary information may be generated based on the missing points data 610 and the test point cloud 304. In at least one embodiment, the circuitry 202 may be configured to generate the supplementary information based on the missing points data 610 and the test point cloud 304. The generation of the supplementary information may involve filtering of one or more 3D points of the selected first set of 3D points (i.e., missing points) that may not be representative of holes in the test point cloud 304. The filtering may be necessary for recovery of errors that may occur during the selection of the first set of 3D points. The error may occur if the local density difference value associated with the locations of a 3D point of the first set of 3D points is close to the density threshold. The error may lead to the selection of the 3D point as a missing point. If the filtering does not take place, a reconstructed point cloud may include two 3D points at the same location (one of the points may be reconstructed by the PCC decoder 118 without the aid of the supplementary information and the other point may be included in the reconstructed point cloud based on the missing points data 610).

From the missing points data 610, the circuitry 202 may determine one or more first 3D points of the first set of 3D points included in the test point cloud 304. The location of a first 3D point in the test point cloud 304 may correspond to a location of a second 3D point of the reference point cloud 302. The one or more first 3D points of the first set of 3D points may act as duplicates of one or more second 3D points of the reference point cloud 302. Therefore, the circuitry 202 may delete data associated with such first 3D points from the missing points data 610. The circuitry 202 may obtain filtered missing points data 612 based on the deletion. The filtered missing points data 612 may be included in the supplementary information.

At 606, a coded bitstream may be generated based on the reference point cloud 302. In at least one embodiment, the circuitry 202 may be configured to generate the coded bitstream (includes the encoded point cloud data).

At 608, the coded bitstream and the supplementary information may be transmitted. In at least one embodiment, the circuitry 202 may be configured to transmit (or signal) the coded bitstream and the supplementary information (i.e., the filtered missing points data 612) to the PCC decoder 118. The coded bitstream and the supplementary information may be received by the external device 104. The encoded point cloud data associated with the reference point cloud 302 may be decoded to generate a reconstructed point cloud. The supplementary information (i.e., the filtered missing points data 612) may be used to process the reconstructed point cloud and generate a final point cloud (with zero or a minimum number of reconstruction artifacts).

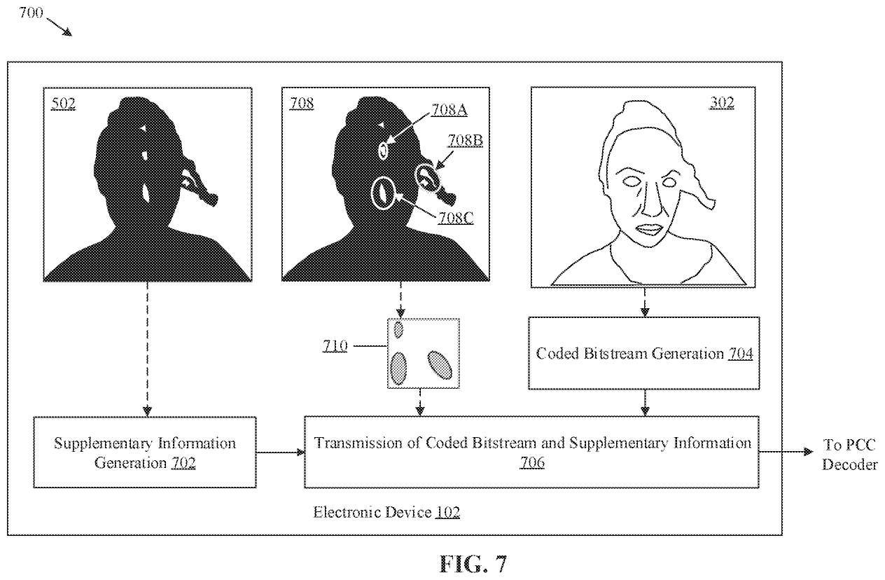

FIG. 7 is a diagram that illustrates an exemplary processing pipeline for generation and signaling of supplementary information to a PCC decoder, in accordance with an embodiment of the disclosure. FIG. 7 is explained in conjunction with elements from FIG. 1, FIG. 2, FIG. 3, FIG. 4A, FIG. 4B, FIG. 5, and FIG. 6. With reference to FIG. 7, there is shown an exemplary processing pipeline 700 for generation of supplementary information and signaling of the supplementary information. In the processing pipeline 700, there is shown a sequence of operations that may start from 702 and end at 706. The sequence of operations may be executed by the circuitry 202 of the electronic device 102. The supplementary information may be generated based on the final density map 502 of FIG. 5. The generated supplementary information may include descriptors for regions of the test point cloud 304 that include geometry reconstruction artifacts such as holes.

At 702, supplementary information may be generated based on the final density map 502. In at least one embodiment, the circuitry 202 may be configured to generate the supplementary information based on the final density map 502. Specifically, the circuitry 202 may determine regions of the final density map 502 where local density differences between the first local density map 404 and the second local density map 412 is greater than the threshold value (i.e., density threshold). Such regions of the final density map 502 may correspond to regions of the test point cloud 304 that include the geometry reconstruction artifacts.

The supplementary information may include descriptors for the regions of the test point cloud 304 that include the geometry reconstruction artifacts (for example, holes). The descriptors may be indicative of the determined regions of the final density map 502 (since the determined regions of the final density map 502 correspond to the regions of the test point cloud 304 that include holes). For example, three descriptors may be indicative of three determined regions of the final density map 502. For each of the three regions, the local density differences between the first local density map 404 and the second local density map 412 may be greater than the threshold value. The three determined regions of the final density map 502 may correspond to three regions of the test point cloud 304 that include holes.

In accordance with an embodiment, each descriptor may be a volume descriptor that indicates a polyhedron structure. The polyhedron structure may correspond to the regions of the test point cloud 304 that includes holes. For example, the polyhedron structure may be an ellipsoid. Thus, three ellipsoids (for example, a first ellipsoid 708A, a second ellipsoid 708B, and a third ellipsoid 708C) may correspond to the three regions of the test point cloud 304 that includes holes. The three ellipsoids may also indicate the three determined regions of the final density map 502 that are representative of the geometry reconstruction artifacts. In accordance with an embodiment, the supplementary information may be generated based on the volume of each of the three ellipsoids, and a region of the test point cloud 304 to which each of the three ellipsoids may correspond to. The generated supplementary information may include volumes of a set of ellipsoids 710 (that includes the first ellipsoid 708A, the second ellipsoid 708B, and the third ellipsoid 708C) and the region of the test point cloud 304 that includes holes.

At 704, a coded bitstream may be generated based on the reference point cloud 302. In at least one embodiment, the circuitry 202 may be configured to generate the coded bitstream (includes encoded point cloud data).

At 706, the coded bitstream and the supplementary information may be transmitted. In at least one embodiment, the circuitry 202 may be configured to transmit (or signal) the coded bitstream and the supplementary information (i.e., the set of ellipsoids 710) to the PCC decoder 118. The coded bitstream and the supplementary information may be received by the external device 104. The encoded point cloud data associated with the reference point cloud 302 may be decoded to generate a reconstructed point cloud. The supplementary information (i.e., the set of ellipsoids 710) may be used to process the reconstructed point cloud and generate a final point cloud (with zero or a minimum number of reconstruction artifacts).

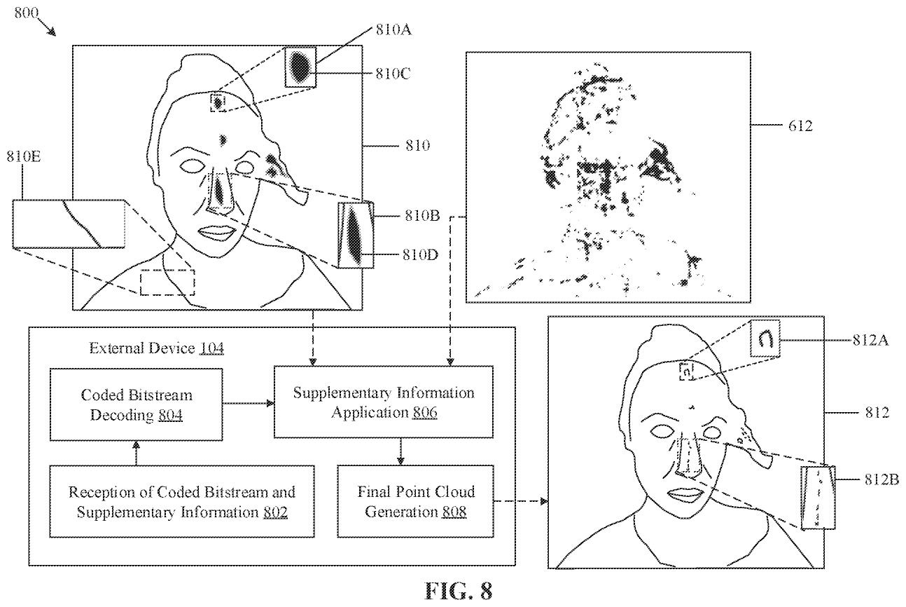

FIG. 8 is a diagram that illustrates an exemplary processing pipeline for mitigation of geometry reconstruction artifacts in a reconstructed point cloud based on received supplementary information, in accordance with an embodiment of the disclosure. FIG. 8 is explained in conjunction with elements from FIG. 1, FIG. 2, FIG. 3, FIG. 4A, FIG. 4B, FIG. 5, FIG. 6, and FIG. 7. With reference to FIG. 8, there is shown an exemplary processing pipeline 800 for detection and mitigation of geometry reconstruction artifacts in a reconstructed point cloud. In the processing pipeline 800, there is shown a sequence of operations that may start from 802 and end at 808. The sequence of operations may be executed by the external device 104. There is further shown a reconstructed point cloud 810 and a final point cloud 812. The reconstructed point cloud 810 may include geometry reconstruction artifacts such as holes. The external device 104 may use the supplementary information for mitigation of geometry reconstruction artifacts in the reconstructed point cloud 810 and generation of the final point cloud 812.

At 802, coded bitstream and supplementary information may be received. In at least one embodiment, the external device 104 may be configured to receive the coded bitstream and the supplementary information from the electronic device 102. The external device 104 or the PCC decoder 118 may extract encoded point cloud data associated with the reference point cloud 302 from the received coded bitstream. In accordance with an embodiment, the supplementary information may include the filtered missing points data 612 (as described in FIG. 6).

The PCC decoder 118 may predict locations in a point cloud (to be reconstructed) that may include geometry reconstruction artifacts. The prediction may be based on the filtered missing points data 612. Such locations may correspond to locations of 3D points of the reference point cloud 302 that are included in the filtered missing points data 612.

At 804, the received coded bitstream may be decoded. In at least one embodiment, the external device 104 may be configured to decode the coded bitstream by use of the PCC decoder 118. The PCC decoder 118 may be configured to decode the encoded point cloud data of the bitstream to generate the reconstructed point cloud 810. The PCC decoder 118 may detect a plurality of regions (for example, a region 810A or a region 810B) in the reconstructed point cloud 810 as regions that include geometry reconstruction artifacts (for example, holes 810C in the region 810A and holes 810D in the region 810B). The detected plurality of regions (i.e., regions 810A and 810B) may include 3D points that are identical to the 3D points included in the filtered missing points data 612. In some embodiments, the PCC decoder 118 may determine local densities at the 3D points in the detected plurality of regions. The PCC decoder 118 may further verify that the local densities in the detected plurality of regions (i.e., regions 810A and 810B) are less than local densities in regions (for example, a region 810E) outside the detected plurality of regions of the reconstructed point cloud 810.

At 806, supplementary information may be applied on the reconstructed point cloud 810. In at least one embodiment, the external device 104 may be configured to apply the received supplementary information (i.e., the filtered missing points data 612) on the reconstructed point cloud 810. The external device 104 may determine, based on the supplementary information, location (i.e., coordinates) of each 3D point included in the filtered missing points data 612. The external device 104 may combine the filtered missing points data 612 with the reconstructed point cloud 810.

At 808, the final point cloud 812 may be generated. In at least one embodiment, the external device 104 may be configured to generate the final point cloud 812. The generation of the final point cloud 812 may be based on the combination of the filtered missing points data 612 with the reconstructed point cloud 810 that includes holes (i.e., the holes 810C and 810D). For example, the combination may lead to transformation of the regions 810A and 810B of the reconstructed point cloud 810 into regions 812A and 812B respectively of the final point cloud 812. Thus, application of the supplementary information may lead to the mitigation of holes in the plurality of regions of the reconstructed point cloud 810.

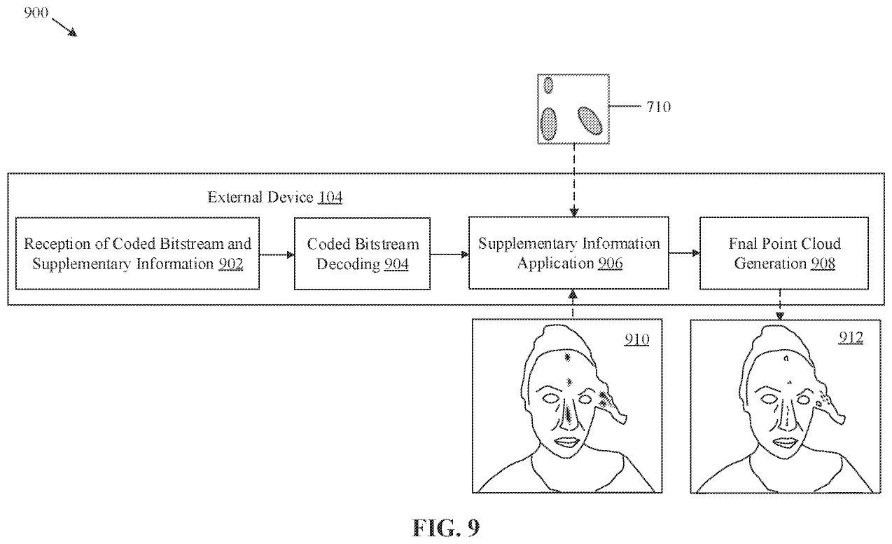

FIG. 9 is a diagram that illustrates an exemplary processing pipeline for mitigation of geometry reconstruction artifacts in a reconstructed point cloud based on received supplementary information, in accordance with an embodiment of the disclosure. FIG. 9 is explained in conjunction with elements from FIG. 1, FIG. 2, FIG. 3, FIG. 4A, FIG. 4B, FIG. 5, FIG. 6, FIG. 7, and FIG. 8. With reference to FIG. 9, there is shown an exemplary processing pipeline 900 for detection and mitigation of geometry reconstruction artifacts in a reconstructed point cloud. In the processing pipeline 800, there is shown a sequence of operations that may start from 902 and end at 908. The sequence of operations may be executed by the external device 104. There is further shown a reconstructed point cloud 910 and a final point cloud 912. The reconstructed point cloud 910 may include geometry reconstruction artifacts. The external device 104 may use the supplementary information for mitigation of geometry reconstruction artifacts in the reconstructed point cloud 910 and generation of the final point cloud 912.

At 902, a coded bitstream and supplementary information may be received. In at least one embodiment, the external device 104 may be configured to receive the coded bitstream and the supplementary information from the electronic device 102. The external device 104 or the PCC decoder 118 may extract encoded point cloud data associated with the reference point cloud 302 from the coded bitstream. In accordance with an embodiment, the supplementary information may correspond to the set of ellipsoids 710 (i.e., the first ellipsoid 708A, the second ellipsoid 708B, and the third ellipsoid 708C).

The PCC decoder 118 may predict regions of a point cloud (to be reconstructed) that may include geometry reconstruction artifacts (for example, holes). Since the set of ellipsoids 710 correspond to regions of the test point cloud 304 that include the holes, the prediction may be based on the set of ellipsoids 710. Such regions of the test point cloud 304 may correspond to the predicted locations of the point cloud (to be reconstructed). The PCC decoder 118 may further predict the volume of each region of the point cloud (to be reconstructed) that may include holes. The prediction may be based on the volume of each ellipsoid of the set of ellipsoids 710. For example, the PCC decoder 118 may predict that a first region of the point cloud (to be reconstructed) may include holes. The volume of the first region may correspond to the volume of a first ellipsoid of the set of ellipsoids 710.

At 904, the coded bitstream may be decoded. In at least one embodiment, the external device 104, via the PCC decoder 118, may be configured to decode the coded bitstream to generate the reconstructed point cloud 910.

At 906, supplementary information may be applied on the reconstructed point cloud 910. In at least one embodiment, the external device 104 may be configured to apply the received supplementary information (i.e., the set of ellipsoids 710) on the reconstructed point cloud 910. The PCC decoder 118 may detect that a plurality of regions of the reconstructed point cloud 910 may include holes. The external device 104 may determine locations inside such regions of the reconstructed point cloud 910 at which point cloud data may need to be inserted to remove the holes from the reconstructed point cloud 910.

The external device 104 may further request the electronic device 102 to send encoded point cloud data associated with 3D points of the reference point cloud 302 and additional supplementary information. The locations of the 3D points of the reference point cloud 302, for which associated encoded point cloud data is requested, may match the determined locations inside the plurality of regions of the reconstructed point cloud 910. The holes may be mitigated based on insertion of point cloud data (obtained from the reference point cloud 302) at the determined locations in the plurality of regions of the reconstructed point cloud 910. The external device 104 may receive the point cloud data as additional supplementary information from the electronic device 102. In an alternate embodiment, an interpolation operation may be applied to fill the locations inside the plurality of regions of the reconstructed point cloud 910 with 3D points.

At 908, the final point cloud 912 may be generated. In at least one embodiment, the external device 104 may be configured to generate the final point cloud 912 based on the insertion of the point cloud data at the determined locations inside the plurality of regions of the reconstructed point cloud 910. The insertion may enable mitigation of holes in the reconstructed point cloud 910 that may typically appear after generation of the reconstructed point cloud 910.

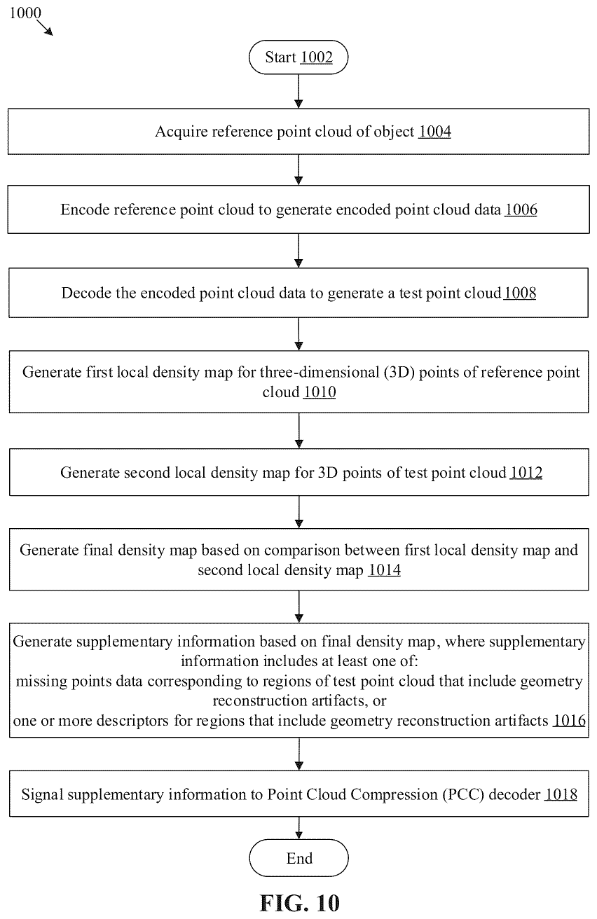

FIG. 10 is a flowchart that illustrates operations for an exemplary method for detection and indication of geometry reconstruction artifacts in point clouds based on local density, in accordance with an embodiment of the disclosure. FIG. 10 is explained in conjunction with elements from FIGS. 1, 2, 3, 4A, 4B, 5, 6, 7, 8, and 9. With reference to FIG. 10, there is shown a flowchart 1000. The operations from 1002 to 1018 may be implemented by any computing system, such as, by the electronic device 102, or the circuitry 202 of the electronic device 102, of FIG. 1. The operations may start at 1002 and may proceed to 1004.

At 1004, a reference point cloud 112 of an object, may be acquired. In at least one embodiment, the circuitry 202 may be configured to acquire the reference point cloud 112 of the object. The details of acquisition of the reference point cloud 112 of the object, is described, for example, in FIG. 1.

At 1006, the reference point cloud 112 may be encoded to generate encoded point cloud data 114. In at least one embodiment, the circuitry 202 may be configured to encode the reference point cloud 112 to generate the encoded point cloud data 114. The details of encoding of the reference point cloud 112 is described, for example, in FIG. 1.

At 1008, the encoded point cloud data 114 may be decoded to generate the test point cloud 116. In at least one embodiment, the circuitry 202 may be configured to decode the encoded point cloud data 114 to generate the test point cloud 116. The details of decoding of the encoded point cloud data 114, is described, for example, in FIG. 1.

At 1010, a first local density map may be generated for 3D points of the reference point cloud 112. In at least one embodiment, the circuitry 202 may be configured to generate the first local density map for the 3D points of the reference point cloud 112. The details of generation of the first local density map, are described, for example, in FIG. 1, FIG. 3, and FIG. 4A.

At 1012, a second local density map may be generated for 3D points of the test point cloud 116. In at least one embodiment, the circuitry 202 may be configured to generate the second local density map for 3D points of the test point cloud 116. The details of generation of the second local density map, are described, for example, FIG. 1, FIG. 3, and FIG. 4B.

At 1014, a final density map may be generated based on a comparison between the first local density map and the second local density map. In at least one embodiment, the circuitry 202 may be configured to generate the final density map based on the comparison between the first local density map and the second local density map. The details of generation of the final density map, are described, for example, in FIG. 1 and FIG. 5.

At 1016, supplementary information may be generated based on the final density map. In at least one embodiment, the circuitry 202 may be configured to generate the supplementary information based on the final density map. The supplementary information may include missing points data corresponding to regions of the test point cloud 116 that include geometry reconstruction artifacts. The supplementary information may further include one or more descriptors for the regions of the test point cloud 116 that include the geometry reconstruction artifacts. The details of generation of the supplementary information, are described, for example, in FIG. 1, FIG. 6, and FIG. 7.

At 1018, the supplementary information may be signaled to the PCC decoder 118. In at least one embodiment, the circuitry 202 may be configured to signal the supplementary information to the PCC decoder 118. The details of signaling of the supplementary information, are described, for example, in FIG. 1, FIG. 6, and FIG. 7. Control may pass to end.

Although the flowchart 1000 is illustrated as discrete operations, such as 1004, 1006, 1008, 1010, 1012, 1014, 1016, and 1018, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (such as the electronic device 102). The computer-executable instructions may cause the machine and/or computer to perform operations that include acquisition of a reference point cloud 112 of an object. The operations may further include encoding of the reference point cloud 112 to generate encoded point cloud data 114. The operations may further include decoding of the encoded point cloud data 114 to generate a test point cloud 116. The operations may further include generation of a first local density map for 3D points of the reference point cloud 112. The operations may further include generation of a second local density map for 3D points of the test point cloud 116. The operations may further include generation of a final density map based on a comparison between the first local density map and the second local density map. The operations may further include generation of supplementary information based on the final density map. The supplementary information may include missing points data corresponding to regions of the test point cloud 116 that include geometry reconstruction artifacts. The supplementary information may also include one or more descriptors for the regions of the test point cloud 116 that include the geometry reconstruction artifacts. The operations may further include signaling of the supplementary information to a PCC decoder 118.

Exemplary aspects of the disclosure may include an electronic device (such as, the electronic device 102 of FIG. 1) that may include circuitry (such as the circuitry 202), that may be communicatively coupled to an external device (such as the external device 104 of FIG. 1). The electronic device 102 may further include memory (such as the memory 204 of FIG. 2). The circuitry 202 may be configured to acquire a reference point cloud 112 of an object. The reference point cloud 112 may be an uncompressed point cloud of the object. The circuitry 202 may be further configured to encode the reference point cloud 112 to generate encoded point cloud data 114. The circuitry 202 may be further configured to decode the encoded point cloud data 114 to generate a test point cloud 116. The circuitry 202 may be further configured to generate a first local density map for 3D points of the reference point cloud 112. The circuitry 202 may be further configured to generate a second local density map for 3D points of the test point cloud 116. The circuitry 202 may be further configured to generate a final density map based on a comparison between the first local density map and the second local density map. The final density map may include a first region for which local density differences between the first local density map and the second local density map is more than that for a second region of the final density map. The circuitry 202 may be further configured to generate supplementary information based on the final density map. The supplementary information may include missing points data corresponding to regions of the test point cloud 116 that include geometry reconstruction artifacts. The supplementary information may also include one or more descriptors for the regions of the test point cloud 116 that include the geometry reconstruction artifacts. Each of the one or more descriptors may correspond to a volume descriptor that is indicative of one or more parameters of a polyhedron structure. The polyhedron structure may correspond to one of the regions of the test point cloud 116 that include the geometry reconstruction artifacts. The geometry reconstruction artifacts may correspond to holes in the test point cloud 116. The circuitry 202 may be further configured to signal the supplementary information to a PCC decoder 118. The encoded point cloud data may be transmitted as a coded bitstream along with the supplementary information to the PCC decoder 118.

In accordance with an embodiment, the circuitry 202 may be further configured to determine a first bounding box for the reference point cloud 112. The circuitry 202 may be further configured to determine a first number of the 3D points of the reference point cloud 112. The circuitry 202 may be further configured to compute a first radius to be used to sample the 3D points of the reference point cloud 112. The first radius may be computed based on the first bounding box and the first number of the 3D points of the reference point cloud 112. The circuitry 202 may be further configured to compute a first spherical volume based on the first radius.

In accordance with an embodiment, the circuitry 202 may be further configured to determine, from the 3D points of the reference point cloud 112, a first number of points in a neighborhood of each 3D point of the reference point cloud 112. The first number of points in the neighborhood may be determined based on a location of a corresponding 3D point of the reference point cloud 112, the reference point cloud 112, and the first radius. The circuitry 202 may be further configured to determine a first local density at each 3D point of the reference point cloud 112, based on the first spherical volume and the first number of points in the neighborhood of the corresponding 3D point. The first local density map may be generated based on the first local density at each 3D point of the reference point cloud 112.

In accordance with an embodiment, the circuitry 202 may be further configured to determine a second bounding box for the test point cloud 116. The circuitry 202 may be further configured to determine a second number of the 3D points of the test point cloud 116. The circuitry 202 may be further configured to compute a second radius to be used to sample the 3D points of the test point cloud 116. The second radius may be computed based on the second bounding box and the second number of the 3D points of the test point cloud 116. The circuitry 202 may be further configured to compute a second spherical volume based on the second radius.

In accordance with an embodiment, the circuitry 202 may be further configured to determine, from the 3D points of the test point cloud 116, a second number of points in a neighborhood of each 3D point of the reference point cloud 112 in the test point cloud 116. The second number of points in the neighborhood may be determined based on a location of a corresponding 3D point of the reference point cloud 112 in the test point cloud 116, the test point cloud 116, and the second spherical radius. The circuitry 202 may be further configured to determine a second local density at each 3D point of the reference point cloud 112 in the test point cloud 116, based on the second spherical volume and the second number of points in the neighborhood of the corresponding 3D point. The second local density map may be generated based on the second local density at each 3D point of the reference point cloud 112 in the test point cloud 116.

In accordance with an embodiment, the circuitry 202 may be further configured to obtain a 3D mask from the final density map, based on a threshold value. The circuitry 202 may be further configured to generate the missing points data based on application of the 3D mask on the reference point cloud 112. The threshold value may correspond to a percentage of voxels that are selectable from the reference point cloud 112 or a percentage of local density differences between the first local density map and the second local density map that is above a difference threshold.

In accordance with an embodiment, the circuitry 202 may be further configured to determine a number of holes in the test point cloud 116 based on the final density map. The holes may correspond to the geometry reconstruction artifacts. The circuitry 202 may be further configured to adjust a number of bits per point until the number of holes is a minimum. The number of bits per point may be used to encode each block of the reference point cloud 112.

In accordance with an embodiment, the circuitry 202 may be further configured to compute, based on the final density map, a first quality metric as a ratio between a number of points in the regions that include the geometry reconstruction artifacts and a total number of the 3D points of the reference point cloud. The supplementary information may further include the first quality metric.

In accordance with an embodiment, the circuitry 202 may be further configured to compute a second quality metric based on the one or more descriptors for which a volume parameter is above a volume threshold. The circuitry 202 may use the final density map 502 for the computation. The supplementary information may further include the second quality metric. In accordance with an embodiment, the circuitry 202 may be further configured to compute a third quality metric as a weighted sum of the first quality metric and the second quality metric. The supplementary information may further include the third quality metric.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. An electronic device, comprising:
circuitry configured to:
acquire a reference point cloud of an object;
encode the reference point cloud to generate encoded point cloud data;
decode the encoded point cloud data to generate a test point cloud;
generate a first local density map for three-dimensional (3D) points of the reference point cloud;
generate a second local density map for 3D points of the test point cloud;
generate a final density map based on a comparison between the first local density map and the second local density map;
generate supplementary information based on the final density map, wherein the supplementary information includes at least one of:
missing points data corresponding to regions of the test point cloud that include geometry reconstruction artifacts, or
one or more descriptors for the regions that include the geometry reconstruction artifacts; and
signal the supplementary information to a Point Cloud Compression (PCC) decoder.

2. The electronic device according to claim 1, wherein the reference point cloud is an uncompressed point cloud of the object.

3. The electronic device according to claim 1, wherein the geometry reconstruction artifacts correspond to holes in the test point cloud.

4. The electronic device according to claim 1, wherein the circuitry is further configured to:
determine a first bounding box for the reference point cloud;
determine a first number of the 3D points of the reference point cloud;
compute a first radius to be used to sample the 3D points of the reference point cloud, wherein the first radius is computed based on the first bounding box and the first number of the 3D points of the reference point cloud; and
compute a first spherical volume based on the first radius.

5. The electronic device according to claim 4, wherein the circuitry is further configured to:
determine, from the 3D points of the reference point cloud, a first number of points in a neighborhood of each 3D point of the reference point cloud,
wherein the first number of points in the neighborhood is determined based on a location of a corresponding 3D point of the reference point cloud, the reference point cloud, and the first radius, and
determine a first local density at each 3D point of the reference point cloud, based on the first spherical volume and the first number of points in the neighborhood of the corresponding 3D point,
wherein the first local density map is generated based on the first local density at each 3D point of the reference point cloud.

6. The electronic device according to claim 1, wherein the circuitry is further configured to:
determine a second bounding box for the test point cloud;
determine a second number of the 3D points of the test point cloud;
compute a second radius to be used to sample the 3D points of the test point cloud, wherein the second radius is computed based on the second bounding box and the second number of the 3D points of the test point cloud; and
compute a second spherical volume based on the second radius.

7. The electronic device according to claim 6, wherein the circuitry is further configured to:
determine, from the 3D points of the test point cloud, a second number of points in a neighborhood of each location in the test point cloud that corresponds to a location of a 3D point of the reference point cloud,
wherein the second number of points in the neighborhood is determined based on the location of the 3D point of the reference point cloud, the test point cloud, and the second spherical radius, and
determine a second local density at each location in the test point cloud that corresponds to a location of a 3D point of the reference point cloud, based on the second spherical volume and the second number of points in the neighborhood of the corresponding location,
wherein the second local density map is generated based on the second local density at each location.

8. The electronic device according to claim 1, wherein the final density map comprises a first region for which local density differences between the first local density map and the second local density map is more than that for a second region of the final density map.

9. The electronic device according to claim 1, wherein the circuitry is further configured to:
obtain a 3D mask from the final density map, based on a threshold value; and
generate the missing points data based on application of the 3D mask on the reference point cloud.

10. The electronic device according to claim 9, wherein the threshold value corresponds to a percentage of voxels that are selectable from the reference point cloud or a percentage of local density differences between the first local density map and the second local density map that is above a difference threshold.

11. The electronic device according to claim 1, wherein each of the one or more descriptors corresponds to a volume descriptor that is indicative of one or more parameters of a polyhedron structure, and the polyhedron structure corresponds to one of the regions that include the geometry reconstruction artifacts.

12. The electronic device according to claim 1, wherein the circuitry is further configured to:
determine a number of holes in the test point cloud based on the final density map, wherein the holes correspond to the geometry reconstruction artifacts; and
adjust a number of bits per point until the number of holes is a minimum, wherein the number of bits per point is to be used to encode each block of the reference point cloud.

13. The electronic device according to claim 1, wherein the circuitry is further configured to compute, based on the final density map, a first quality metric as a ratio between a number of points in the regions that include the geometry reconstruction artifacts and a total number of the 3D points of the reference point cloud, and wherein the supplementary information further includes the first quality metric.

14. The electronic device according to claim 13, wherein the circuitry is further configured to compute, based on the final density map, a second quality metric as a reciprocal of a number of the one or more descriptors for which a volume parameter is above a volume threshold, and wherein the supplementary information further includes the second quality metric.

15. The electronic device according to claim 14, wherein the circuitry is further configured to compute a third quality metric as a weighted sum of the first quality metric and the second quality metric, and wherein the supplementary information further includes the third quality metric.

16. The electronic device according to claim 1, wherein the circuitry is further configured to transmit the encoded point cloud data as a coded bitstream along with the supplementary information to the PCC decoder.

17. A method, comprising:
in an electronic device:
acquiring a reference point cloud of an object;
encoding the reference point cloud for generating encoded point cloud data;
decoding the encoded point cloud data for generating a test point cloud;
generating a first local density map for three-dimensional (3D) points of the reference point cloud;
generating a second local density map for 3D points of the test point cloud;
generating a final density map based on a comparison between the first local density map and the second local density map;
generating supplementary information based on the final density map, wherein the supplementary information includes at least one of:
missing points data corresponding to regions of the test point cloud that include geometry reconstruction artifacts, or
one or more descriptors for the regions that include the geometry reconstruction artifacts; and
signaling the supplementary information to a Point Cloud Compression (PCC) decoder.

18. The method according to claim 17, wherein the reference point cloud is an uncompressed point cloud of the object.

19. The method according to claim 17, wherein the geometry reconstruction artifacts correspond to holes in the test point cloud.

20. A non-transitory computer-readable medium having stored thereon, computer executable instruction, which when executed by a computer, causes the computer to perform operations, the operations comprising:
acquiring a reference point cloud of an object;
encoding the reference point cloud for generating encoded point cloud data;
decoding the encoded point cloud data for generating a test point cloud;
generating a first local density map for three-dimensional (3D) points of the reference point cloud;
generating a second local density map for 3D points of the test point cloud;
generating a final density map based on a comparison between the first local density map and the second local density map;
generating supplementary information based on the final density map, wherein the supplementary information includes at least one of:
missing points data corresponding to regions of the test point cloud that include geometry reconstruction artifacts, or
one or more descriptors for the regions that include the geometry reconstruction artifacts; and
signaling the supplementary information to a Point Cloud Compression (PCC) decoder.
